(19) United States
(12) Patent Application Publication
(10) Pub. No.: US 2009/0207412 A1
(43) Pub. Date: Aug. 20, 2009

(54) Multi-channel Optical Imaging

(76) Inventors: Umar Mahmood, Boston, MA (US); Martin A. Funovics, Vienna (AT); Ralph Weissleder, Peabody, MA (US)

Correspondence Address: FISH & RICHARDSON PC, P.O. BOX 1022, MINNEAPOLIS, MN, 55440-1022, US

(21) Appl. No.: 10/596,735

(22) PCT Filed: Dec. 23, 2004
(86) PCT No.: PCT/US04/43746

§ 371 Date: Apr. 24, 2009

Related U.S. Application Data
(60) Provisional application No. 60/532,366, filed on Dec. 24, 2003.

(51) Int. Cl. G01N 21/25; G02B 27/14

(52) U.S. Cl. 356/406; 359/634; 359/350

(57) ABSTRACT

A beam splitter array includes first and second beam splitters and a reflector to reflect part of a beam from the second splitter. The first splitter outputs a first beam having a power spectral density comprising a substantial portion of a white light spectrum from a first output port, and a second beam of optical radiation having a power spectral density comprising a substantial portion of a first non-white spectrum and a substantial portion of a second non-white spectrum from a second output port, from an input beam received at a first angle of incidence. The second splitter receives the second beam at a second incidence angle, and reflects a substantial portion of the second beam having a power spectral density comprising the first non-white light spectrum, and transmits a substantial portion of the second beam having a power spectral density comprising the second non-white light spectrum.

### CROSS-REFERENCE TO RELATED APPLICATIONS

This application claims the benefit under 35 USC § 119 of U.S. Provisional Patent Application Ser. No. 60/532,366, filed on Dec. 24, 2003, the entire contents of which is incorporated herein by reference.

### STATEMENT AS TO FEDERALLY SPONSORED RESEARCH

This invention was made with government support under grant EB001872 awarded by NIBIB. The government has certain rights in the invention.

### BACKGROUND OF THE INVENTION

The invention relates to multi-channel optical imaging.

Optical imaging systems can be used to record images from various types of biological tissue, e.g., in vivo. The images are used to detect features that can help in diagnosing various diseases. White light imaging systems use a device such as a fiber optic endoscope or angioscope to illuminate tissue and collect resulting reflected and scattered light to form an image of the anatomical appearance of the tissue. Fluorescence imaging systems use a similar device to provide details of biological parameters based on auto-fluorescence (fluorescent emission from the tissue itself) or fluorescence from an extrinsically applied agent (e.g., a fluorescent protein such as green fluorescent protein (GFP)).

### SUMMARY OF THE INVENTION

The invention is based on the recognition that combining a white light optical channel with two or more non-white light optical channels in the same optical imaging system increases the system's ability to accurately detect certain features in biological tissue, e.g., in vivo, in animals, such as mammals, e.g., humans. The new devices and methods can be used for optical imaging in vivo, e.g., to image cancerous or otherwise diseased or infected tissues.

In general, in one aspect, the invention features beam splitter arrays that include a first beam splitter that outputs a first beam of optical radiation having a power spectral density including a substantial portion of a white light spectrum from a first output port, and that outputs a second beam of optical radiation having a power spectral density including a substantial portion of a first non-white light spectrum and a substantial portion of a second non-white light spectrum from a second output port, from an input beam received at a first angle of incidence; a second beam splitter, arranged to receive the second beam at a second angle of incidence, that reflects a substantial portion of the second beam having a power spectral density including the first non-white light spectrum, and that transmits a substantial portion of the second beam having a power spectral density including the second non-white light spectrum; and a reflector arranged to reflect a substantial portion of the beam transmitted by the second beam splitter.

In some embodiments, the first output port is a surface of the first beam splitter through which light is transmitted, and the second output port is a different surface of the first beam splitter from which light is reflected. In other embodiments, the first output port is a surface of the first beam splitter from which light is reflected, and the second output port is a different surface of the first beam splitter through which light is transmitted.

In these arrays, the second beam splitter can be further arranged to reflect the first beam in a first direction, and the reflector can be further arranged to reflect the second beam in a second direction that is within 20° of the first direction. The first beam splitter can have an optical transmittance spectrum that is larger than 0.5 (e.g., larger than 0.7 or 0.8) over at least 50% (e.g., over 60, 70, or 80%) of the white light spectrum that includes wavelengths between about 400 nanometers and 670 nanometers, and an optical reflectance spectrum that is larger than 0.5 (e.g., larger than 0.7 or 0.8) over the first non-white light spectrum that does not overlap the white light spectrum and is larger than 0.5 (e.g., larger than 0.7 or 0.8) over the second non-white light spectrum that does not overlap the white light spectrum or the first non-white light spectrum. The second beam splitter can have an optical reflectance spectrum that is larger than 0.5 (e.g., larger than 0.7 or 0.8) over the first non-white light spectrum, and an optical transmittance spectrum that is larger than 0.5 (e.g., larger than 0.7 or 0.8) over the second non-white light spectrum. In certain embodiments, the reflector can have an optical reflectance spectrum that is larger than 0.5 (e.g., larger than 0.7 or 0.8) over the second non-white light spectrum.

In various embodiments of the beam splitter array, the first non-white light spectrum can include a near-infrared spectrum, or a narrowband visible spectrum. For example, the first non-white light spectrum can have wavelengths between about 680 nanometers and about 720 nanometers. In certain embodiments, the second non-white light spectrum can include wavelengths between about 760 nanometers and about 800 nanometers.

The beam splitter array can further include a first filter that has a bandpass transmittance spectrum centered at about 700 nm arranged to receive the first beam; and a second filter that has a bandpass transmittance spectrum centered at about 780 nm arranged to receive the second beam.

In another aspect, the invention features systems that includes the beam splitter arrays described herein; a first filter that has a bandpass transmittance spectrum centered at about 700 nm arranged to receive a beam of optical radiation reflected from the second beam splitter at the second angle of incidence; a second filter that has a bandpass transmittance spectrum centered at about 780 nm arranged to receive a beam of optical radiation reflected from the reflector; a first waveguide arranged to deliver optical radiation radiated from biological tissue to the first beam splitter at the first angle of incidence; a first detector arranged to receive a beam of optical radiation output from the first beam splitter at the first angle of incidence; and a second detector arranged to receive a beam of optical radiation reflected from the second beam splitter and a beam of optical radiation reflected from the reflector. The first detector can include a camera. The second detector can include a single camera arranged to receive the beam of optical radiation reflected from the second beam splitter and the beam of optical radiation reflected from the reflector. Alternatively, the second detector can include two cameras arranged to receive the beam of optical radiation reflected from the second beam splitter and the beam of optical radiation reflected from the reflector, respectively.

These systems can further include a source of optical radiation that includes white light; and a second waveguide arranged to deliver the optical radiation produced by the source to the biological tissue. In certain embodiments, the source can be filtered to reduce the white light in the first non-white light spectrum and the second non-white light spectrum, or the source can include a broadband white light source, e.g., a xenon lamp, optionally combined with a narrowband non-white light source, such as a laser diode.

The invention also features methods for optical imaging, e.g., in vivo, that include illuminating a sample, e.g., biological tissue, with optical radiation from a source of optical radiation that includes white light; collecting optical radiation from the sample; delivering the collected optical radiation to a beam splitter array; detecting a first image of optical radiation with a power spectral density that includes a white light spectrum from the beam splitter array; detecting a second image of optical radiation with a power spectral density that includes a first non-white light spectrum from the beam splitter array; and detecting a third image of optical radiation with a power spectral density that includes a second non-white light spectrum from the beam splitter array. The beam splitter array can be as described herein.

In certain embodiments, two or more of the first, second, and third images are detected simultaneously, or two or more of the first, second and third images are recorded and/or displayed, or two or more of the first, second, and third images can be combined using a mathematical function.

As used herein, the term “white light” means optical radiation having a power spectral density that is nonzero over a substantial portion of the range of wavelengths from about 400 nanometers to about 670 nanometers.

As used herein, a beam splitter “outputs” a portion of an incoming beam “from an output port” either by reflecting the portion of the beam or by transmitting the portion of the beam.

The invention provides several advantages. For example, the beam splitter array provides separation of a white light channel and multiple auxiliary channels for simultaneous independent recording of the white light channel and the auxiliary channels with a minimal number of reflections in a compact beam splitter array structure. The structure is suitable for the independent probing of two molecular or physiologic parameters at the same time and in the same sample, in both video (e.g., real-time video) and still capture modes. The simultaneously recorded and displayed white light image provides anatomic orientation.

When one or more of the auxiliary channels include wavelengths in the near-infrared (NIR), fluorescent probes with high target-to-background and activation ratios can be used. Also, NIR light penetrates biological tissue more easily than visible light.

Multiple auxiliary channels enable diverse biological imaging applications including: colocalization of multiple targets, determination of expression/activity ratios between targets, disease characterization based on multiple attributes, and better quantitation by the introduction of a reference channel, which can compensate for differences in probe delivery and tissue absorption in heterogeneous disease states. Multiple auxiliary channels can also be used to compensate for effects that could skew the quantitation in a system with only one or no auxiliary channels, e.g., variability in illumination angle of the target and distance to target from the endoscope tip. The effects of inhomogeneous probe distribution may also be corrected for by the co-injection of a reference non-activatable contrast agent, which may be recorded in a reference NIR channel.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will become apparent from the following description, and from the claims.

### BRIEF DESCRIPTION OF THE DRAWINGS

FIG. 1 is a schematic illustration of an optical imaging system.

FIG. 2 is a schematic illustration of an illumination source for the optical imaging system.

FIG. 3 is a schematic illustration of a portion of the optical imaging system including collection optics.

FIG. 4 is a transmittance spectrum for a beam splitter in the optical imaging system.

FIGS. 5A-5F are graphs of NIR channel power spectral densities at various locations in the optical imaging system.

FIGS. 6A and 6B are graphs of relative signal intensity versus fluorochrome concentration for auxiliary channels.

FIGS. 7A-7C are representations of a portion of a biological tissue for the white light channel and the two auxiliary channels.

FIGS. 8A and 8B are representations of combinations of the images in FIGS. 7A-7C.

FIGS. 9A-9C are representations of magnified images of targeted and normal colon tissue.

### DETAILED DESCRIPTION

### Optical Imaging System

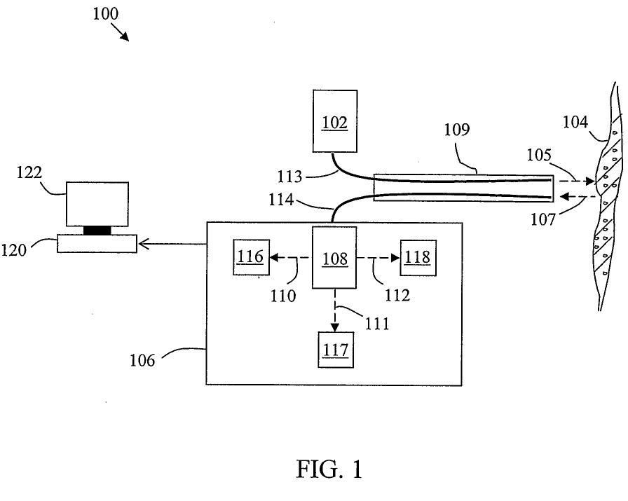

As shown in FIG. 1, an optical imaging system 100 includes an illumination source 102 for illuminating biological tissue 104 of a subject with illumination radiation 105, and imaging module 106 for simultaneously recording multiple real-time video images from the biological tissue 104. The imaging module 106 includes a beam splitter array 108 for spatially separating the collected optical radiation 107 into a white light channel 110 and two auxiliary channels 111 and 112. The white light channel 110 includes a significant portion of the visible spectrum (i.e., a wavelength range of approximately 400-670 nm). The auxiliary channels 111 and 112 can include any of a variety of spectral bands useful for imaging biological tissue, for example, near-infrared (NIR), ultraviolet (UV), or a narrow visible band.

The illumination source 102 includes one or more sources of optical radiation (e.g., a lamp or a laser) to illuminate the biological tissue 104. Any of a variety of techniques can be used to deliver the optical radiation to (and collect optical radiation from) the biological tissue 104. For example, the optical imaging system 100 can use a fiber optic endoscope or angioscope (such as colonoscope or bronchoscope, or a catheter for cardiovascular imaging of vessels such as the coronary arteries), or a device that directly relays an optical image from inside the body (e.g., a borescope or miniaturized telescope), or an objective lens that provides an image from a certain distance from a target (e.g., a microscope or camera lens). In the example in FIG. 1, an endoscope 109 includes an illumination optical fiber bundle 113 that delivers illumination optical radiation. Optical radiation that is reflected, scattered, or otherwise emitted from the biological tissue 104 is collected into an imaging optical fiber bundle 114 and delivered to the imaging module 106.

The imaging module 106 detects the radiation from the white light channel 110 in a visible light camera 116 (e.g., a charge-coupled device (CCD) camera) and simultaneously detects radiation from the auxiliary channels 111 and 112 in auxiliary cameras 117 and 118, respectively. The cameras 117 and 118 can be implemented using a detector having a single CCD chip arranged to image beams for the two channels on two respective areas on the CCD chip. Alternatively, the cameras 117 and 118 can be implemented as two separate CCD chips or some other form of a detector with or without image intensifiers. The cameras 116-118 generate images that are captured in a computer 120 (e.g., using a commercially available image/video capture card with multiple inputs). The imaging module 106 may optionally include filters (e.g., bandpass filters) for further isolating the spectral channels 110-112. In the case of an auxiliary channel 111 that is used to detect fluorescence in a portion of the visible spectrum, the white light channel 110 is filtered to remove that portion of the visible spectrum so that the auxiliary channel camera 117 is not flooded with background signal due to reflected light from the white light channel 110. The computer 120 displays the still or motion images from the channels 110-112 on a display 122.

The optical imaging system 100 can be used with “molecular probes” including fluorescence probes that emit substantial fluorescence only after interaction with a target tissue (i.e., after they are “activated”). Such molecular probes increase the target/background ratio by several orders of magnitude and enable non-invasive NIR imaging of internal target tissues in vivo, based on enzymatic activity present in the target tissue, as described more fully in, e.g., U.S. Pat. No. 6,083,486 and U.S. Pat. No. 6,615,063, the complete contents of which are incorporated herein by reference.

In one example, an optical imaging system is designed for a first auxiliary channel having a “low” near-infrared (NIR) spectrum including a wavelength range of about 690-720 nm, and a second auxiliary channel having a “high” NIR spectrum including a wavelength range of about 760-800 nm. In the optical imaging system described below, fluorochromes Cy5.5 and Cy7 are introduced into the target biological tissue to emit fluorescence for the low NIR and high NIR channels, respectively. The spectral characteristics of the illumination source, the imaging module and other parts of the system are selected to be compatible with the spectral properties of these fluorochromes. Alternatively, an optical imaging system can be designed to be compatible with other non-white light auxiliary channels.

### Illumination Source

The illumination source 102 can include a single source of optical radiation, or a combination of sources selected to provide sufficient power in the spectral bands to be illuminated. For example, a source providing power in a tail of a broadband spectrum can be supplemented with a narrowband source, such as a laser. Such a narrowband source can provide excitation radiation for a probe with an excitation band not sufficiently excited by the broadband source. One or more filters can be used to reduce optical radiation in a band of an auxiliary channel, for example, to reduce background signal in a fluorescence band.

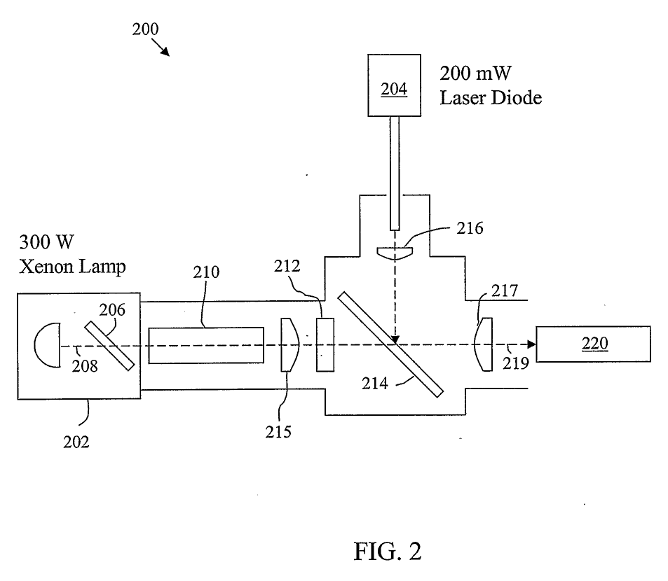

FIG. 2 shows an illumination source 200 that includes a lamp 202 (e.g., a 300 W xenon lamp, Minimally Invasive Surgical Technologies, Smithfield, N.C.) that provides wide band visible illumination radiation for the white light channel and excitation radiation for the low NIR channel. A laser 204 (e.g., a 200 mW GaAs diode laser, Ceramoptec, Bonn, Germany) provides narrowband excitation radiation with a center wavelength of about 739 nm for the high NIR channel. The lamp 202 includes a filter 206 mounted at 45° to the propagation axis 208 to transmit a range of wavelengths of approximately 350-720 nm. A glass optical fiber bundle 210 guides the visible radiation to a shortpass filter 212 that has a cutoff wavelength of about 690 nm (that transmits radiation with a shorter wavelength than the cutoff wavelength). This shortpass filter 212 ensures that the low and high NIR channels are not flooded by reflected light from the lamp 202. A dichroic mirror 214 combines the visible radiation from the lamp 202 with the high NIR excitation radiation from the laser 204. Coupling lenses 215-217 optimize spatial coupling of a resulting superimposed beam 219 into an illumination optical fiber bundle 220 of an endoscope (e.g., a fiber optic endoscope, Baxter, Irvine, Calif.).

### Imaging Module

The imaging module 106 can include any of a variety of optical elements to separate the collected optical radiation 107 into a white light channel 110 and two auxiliary channels 111 and 112. The beam splitter array 108 can be implemented using bulk optical components, optical fiber coupled components, or any other optical media capable of splitting the spectral channels 110-112 into separate beams.

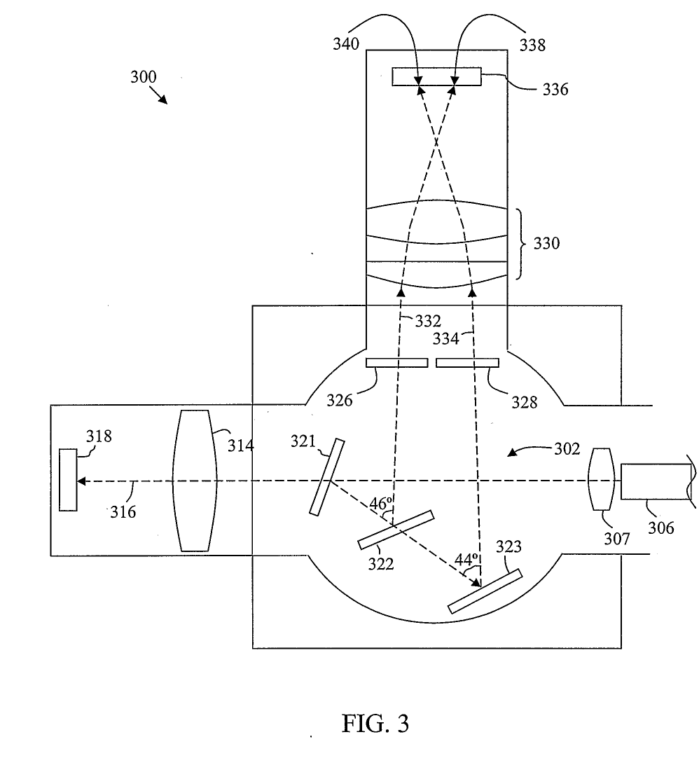

FIG. 3 shows an imaging module 300 that includes a beam splitter array 302 that receives collected radiation from an imaging optical fiber bundle 306. Optical radiation from the illumination source 200 excites the fluorochromes Cy5.5 and Cy7 in the biological tissue 104. The excited fluorochromes emit fluorescent radiation that is coupled into the endoscope's imaging optical fiber bundle 306. The wide band visible illumination radiation is also reflected and scattered from the biological tissue and coupled into the imaging optical fiber bundle 306 along with the emitted fluorescent radiation.

The imaging optical fiber bundle 306 delivers the collected radiation to the beam splitter array 302. A collimating lens 307 can be mounted near the end of the imaging optical fiber bundle 306 externally or as an integrated part of the bundle. The beam splitter array 302 includes a first beam splitter 321 that outputs the white light portion of the collected radiation from a first output port and outputs a wavelength range of 700-900 nm that includes both NIR channels, from a second output port with an incident angle of approximately 20°. In this embodiment, the first output port corresponds to a surface of the beam splitter 321 through which light is transmitted and the second output port corresponds to a surface of the beam splitter 321 from which light is reflected. In some embodiments, the first output port corresponds to a surface of the beam splitter 321 from which light is reflected and the second output port corresponds to a surface of the beam splitter 321 through which light is transmitted. In other embodiments, the first and second output ports correspond to output couplers, for example, fiber optic couplers from a fiber optic beam splitter (e.g., a fiber Bragg grating, an optical circulator, etc.). An objective lens 314 focuses the white light beam 316 onto a CCD chip 318 of a color video camera (e.g., a Series 8290, Cohu, San Diego, Calif.) that records a real-time video image of the biological tissue.

The optical transmittance spectrum of the beam splitter 321 should be large enough to transmit a substantial portion of the white light spectrum. For example, the transmittance spectrum should be larger than 0.5 (e.g., larger than 0.6, 0.7, 0.8, or larger) over most of the white light spectrum. The transmittance spectrum does not necessarily need to be larger than 0.5 over an entirely contiguous portion of the white light spectrum, but the total portion of the white light spectrum over which the transmittance is larger than 0.5 should be larger than 50%, e.g., larger than 70% or 80%, or even larger than 90%. In useful embodiments, the transmittance spectrum is larger than 0.8 over most of the white light spectrum, e.g., over about 75% or greater.

A second beam splitter 322 is highly reflective over a wavelength range of about 680-720 nm that includes the low NIR channel, and highly transmissive over a wavelength range of about 760-800 nm that includes the high NIR channel. Collected fluorescence from the Cy5.5 fluorochrome is reflected by the second beam splitter 322 at an incidence angle of approximately 23° and directed to a low NIR bandpass filter 326 that transmits a wavelength range of about 690-720 nm. Collected fluorescence from the Cy7 fluorochrome is transmitted by the second beam splitter 322 and reflected by a reflector 323 into a high NIR bandpass filter 328 that transmits a wavelength range of about 760-800 nm. The reflector 323 is a broadband mirror. Alternatively, the reflector 323 can be highly reflecting over a narrow wavelength range that includes the high NIR channel.

Selective beam splitters such as beam splitter 321 and beam splitter 322 can be made using any of a variety of standard techniques. Such a beam splitter can include multiple dielectric layers selected to provide a desired transmittance spectrum. Alternatively, such a beam splitter can include material that has an intrinsic transmittance matching a desired transmittance spectrum. Other techniques are possible including the use of selectively absorbing material.

A compound objective lens 330 focuses the filtered Cy5.5 fluorescent beam 332 and the filtered Cy7 fluorescent beam 334 onto a CCD chip 336 (e.g., an ICX 248AL CCD, Sony Instrument) of a NIR video camera (e.g., a StellaCam EX, Adirondack Video, NY). The angle between the propagation axis of the Cy5.5 fluorescent beam 332 and the propagation axis of the Cy7 fluorescent beam 334 is selected such that two separate images for the low and high NIR channels are formed next to each other on the CCD chip 336. The center of the low NIR image 338 and the center of the high NIR image 340 are close enough for the images to be recorded by the same CCD chip 336, and far enough apart for the images not to overlap and interfere with each other. Thus, the low NIR and high NIR channels are recorded independently, yet simultaneously, using a single CCD chip. In this embodiment, the beams 332 and 334 are substantially parallel to each other with a relative angle of approximately 2° between them. In other embodiments, the beams 332 and 334 can have larger angles between them (e.g., 3°, 6°, 12°, 20°) and still be directed to the same CCD chip.

### Image Recording

The image of the white light channel on the CCD chip 318 of the color camera, and the separate images of the low NIR and high NIR channels formed next to each other on the CCD chip 336 of the NIR camera are simultaneously displayed on a computer screen. The imaging optical fiber bundle 306 is large enough to collect sufficient optical radiation for clearly imaging features in the biological tissue. In this example, the imaging optical fiber bundle 306 has 15,000 fibers and a 0.5 mm diameter, but other numbers of fibers (e.g., 100, 500, 1000, 2500, 5000, 7500, 10,000, or 20,000) and diameters (e.g., 0.1, 0.25, 0.75, 1.0, 2.5, or 5.0 mm) are possible. The resolution of the imaging optical fiber bundle 306 is approximately 7 line pairs per millimeter. The CCD chips 318 and 336 record a circular image, for each of the three channels, of approximately 130 pixels in diameter. The image integration times are short enough (around 0.1-1 seconds/frame) to avoid motion artifacts, and large enough to collect a sufficient amount of light. Alternatively, larger optical fiber bundles can be used (e.g., 2, 3, 4, or 5 mm in diameter) with shorter integration times.

Along with display and storage of still and video frames of the white light and NIR channels, image-processing software (e.g., the public domain NIH Image program available on the internet from the National Institutes of Health at rsb.info.nih.gov/nih-image, or Scion Image available from Scion Corporation) enables generation of calculated images that combine information from the channels. For example, real-time or near real-time image streams are displayed as overlay, false-colored images, subtraction images, or division images. Other mathematical functions can be used to process the images, including noise-filtering techniques, ratio imaging, threshold detection and/or prior probability analysis to facilitate the detection of biological information (including localization of disease).

The imaging module 300 includes features to increase sensitivity to detecting the NIR fluorescent light. When the eyepiece of the endoscope is correctly focused, the image coming from the imaging optical fiber bundle 306 is collimated for image points along the optical axis. Since the entire area of the optical fiber bundle is imaged, the emerging rays will be divergent, as determined by the diameter of the optical fiber bundle and the focal length of the eyepiece. Thus, the lenses 314 and 330 that refocus the collimated light onto the respective CCD chips 318 and 336 should be of a sufficient size so that the resulting aperture does not limit sensitivity. The CCD chip 336 used for imaging the NIR channels can also include features increasing sensitivity such as the use of high NIR light response, image intensifiers, large on-chip microlenses, that reduce the inefficient area of the chip, and improve overall quantum-efficiency to about 62% at 700 nm, and about 45% at 750 nm. Alternatively, thinned back illuminated and cooled CCDs or CCDs with image intensifiers can be used.

### Spectral Tuning and Filtering

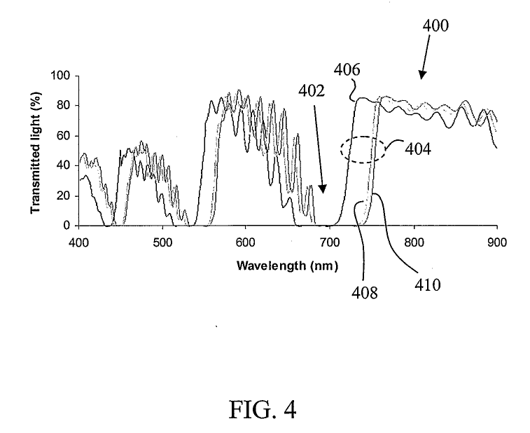

The wavelength bands that are transmitted and/or reflected by beam splitters and filters in the optical imaging system can be tuned, for example, by a change in the angle of incidence of the incoming beam. FIG. 4 shows the transmittance spectrum of the second beam splitter 322 at incident angles of 45° (curve 406), 23° (curve 408), and 0° (curve 410) from normal, as measured by a spectrophotometer (U3000, Hitachi, Tokyo, Japan). Selection of this incidence angle enables fine-tuning of the high NIR spectral band 400 that is transmitted (with a transmittance above approximately 60%) and the low NIR spectral band 402 that is reflected (with a transmittance below approximately 10%). An optimized separation of the two NIR channels is obtained by fine-tuning the cutoff wavelength 404 (where the transmittance crosses 50%) of the second beam splitter 332, which is dependent on the angle of incidence. Changing the angle of incidence from 0° to 45° results in a shift of 23 nm in the cutoff wavelength 404. By adjusting the incidence angle on the second beam splitter 322 to 23°, and arranging the first beam splitter 321 and the reflector 323 accordingly, optimal channel separation with minimal light loss is obtained.

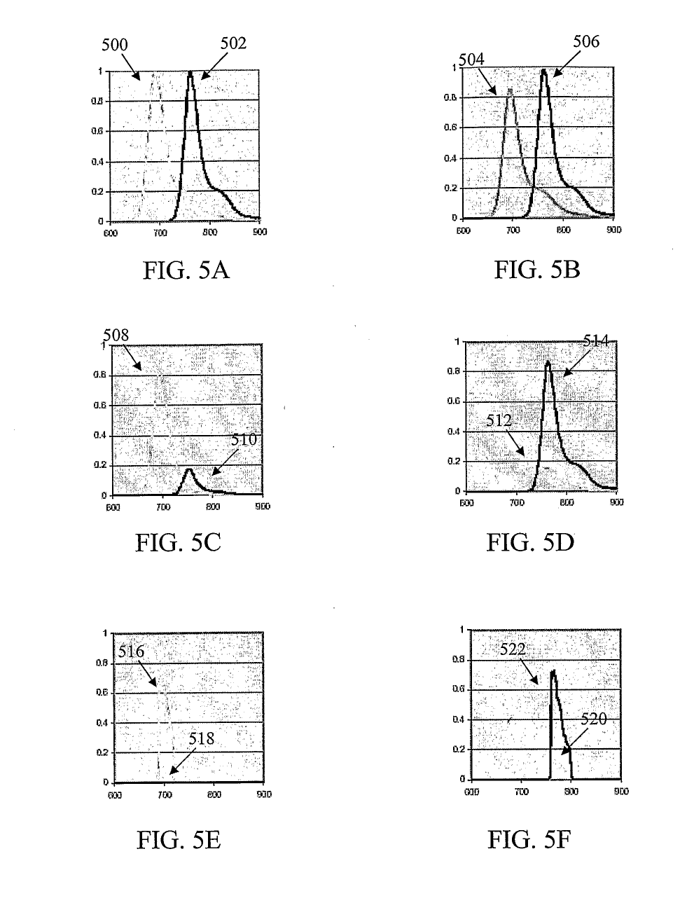

FIGS. 5A-5F show relative power spectral density curves for the two NIR channels at various locations in the imaging module 300 calculated using the transmission and reflection curves for each of the optical components in the imaging module 300 as measured spectrophotometrically. FIG. 5A shows curves of the emission spectra for the Cy5.5 fluorochrome (curve 500) and for the Cy7 fluorochrome (curve 502) assuming 100% input at both the maximum emission wavelengths of Cy5.5 and Cy7. The spectral filtering of the imaging system progressively removes unwanted fluorescence. Referring to FIG. 5B, after the first beam splitter 321, the relative peak intensities are 83% (curve 504) and 97% (curve 506) for Cy5.5 and Cy7 fluorescence, respectively, in the single NIR beam. After the second beam splitter 322, where the low NIR and high NIR channels separate, peak intensities become 82% (curve 508) and 18% (curve 510) in the low NIR channel (FIG. 5C), and 17% (curve 512) and 85% (curve 514) in the high NIR channel (FIG. 5D), for Cy5.5 and Cy7 fluorescence, respectively. Referring to FIG. 5E, after the low NIR bandpass filter 326, 68% (curve 516) and 0% (curve 518) remain in the low NIR channel, for Cy5.5 and Cy7 fluorescence, respectively. Referring to FIG. 5F, after the high NIR bandpass filter 328, 12% (curve 520) and 72% (curve 522) remain in the high NIR channel, for Cy5.5 and Cy7 fluorescence, respectively.

### Signal Intensity

The concentration and quantum efficiency of the fluorochromes in the target region of the biological tissue is an additional factor that affects sensitivity. A way to improve sensitivity is by developing fluorochromes with improved quantum efficiency, as well as with the use of less-quenching fluorochromes to allow a more intense “perfusion imaging” signal. Moreover, as fluorochromes are used with excitation and emission spectra spaced further apart, the pass bands of bandpass filters 326 and 328 can be broadened to collect a greater percentage of the respective fluorescent photons without increasing crosstalk.

Sensitivity was tested by imaging serial dilutions of Cy5.5 and Cy7 in phosphate-buffered saline, with concentrations from 30 nM to 10 μM in a 96-well plate. The tip of the endoscope was immersed at an angle of 45° to avoid reflection of excitation light from the bottom of the wells. The NIR camera was set to integrate 30 video frames at 1/60 second each. The signal intensities of the central region both in the low NIR and in the high NIR channels were measured using custom software (CMIR Image), and normalized to percentages of the maximum saturation values.

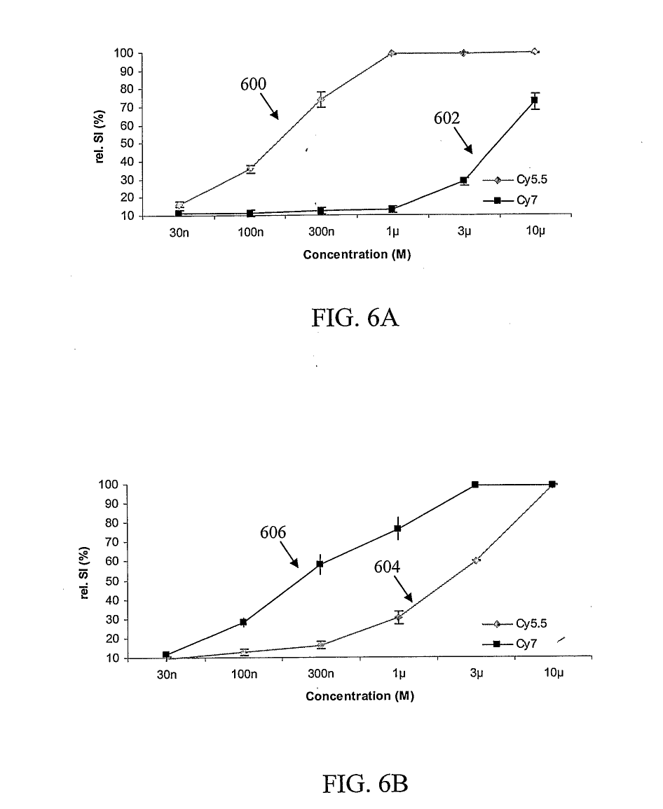

Referring to FIGS. 6A and 6B, relative signal intensity (SI) verses fluorochrome concentration is plotted for the low NIR channel (FIG. 6A) and for the high NIR channel (FIG. 6B). Error bars represent standard deviation. The Cy5.5 curve 600 for the low NIR channel rises to a high level earlier than the Cy7 curve 602 for the low NIR channel. Similarly, the Cy7 curve 604 for the high NIR channel rises to a high level earlier than the Cy5.5 curve 606 for the high NIR channel. Signal intensity that the Cy5.5 fluorochrome contributes to the high NIR channel, and signal intensity that the Cy7 fluorochrome contributes to the low NIR channel represent “interchannel crosstalk,” and is undesirable.

### Crosstalk Compensation

To improve the accuracy of quantitative measurements of fluorochrome concentrations, the changes in interchannel crosstalk at a given concentration is determined experimentally. Regression lines are fit to the linear parts of the SI versus concentration curves using the least squares method, and compensation terms for interchannel crosstalk are formulated. Crosstalk between the NIR channels is partially a result of the broad tails in the spectra of commonly used organic fluorochromes.

To compensate for this interchannel crosstalk, the linear part of the curve defining the relation between fluorochrome concentration and SI for each channel is used to obtain a linear fit to the data for the curve. The total SI for the high NIR channel (SI_{NIR700}), and the total SI for the low NIR channel (SI_{NIR780}) are given by:

SI_{NIR700}=a[con(Cy5.5)]+b[con(Cy7)]

SI_{NIR780}=c[con(Cy5.5)]+d[con(Cy7)]

where [con(Cy5.5)] and [con(Cy7)] are the concentrations of the two fluorochromes. SI is the normalized signal intensity of the CCD camera ranging from 0 to 1 at full saturation. The coefficients b and c represent the amount of SI which is generated by fluorescence in the respective other channel (interchannel crosstalk). The equations solved for [con(Cy5.5)] and [con(Cy7)] yield:

$$[ con ( Cy5 .5 ) ] = \frac{{dSI}_{NIR700} - {bSI}_{NIR780}}{ad - bc} \\ [ con ( Cy7 ) ] = \frac{{aSI}_{NIR780} - {cSI}_{NIR700}}{ad - bc}$$

From the SI verses concentration curves (FIGS. 6A-6B), regression is performed in the linear region of the curves between 30 nM and 1 μM for NIR₇₀₀ and 30 nM and 3 μM for the high NIR channel. The respective coefficients are calculated to be: a=1.00 μM⁻¹, b ˜0.16 μM⁻¹, c=0.056 μM⁻¹, and d=0.751 μM⁻¹. The proper compensations for interchannel crosstalk are therefore:

[con(Cy5.5)]/μM=1.01*SI_{NIR700}-0.22*SI_{NIR780}

[con(Cy7)]/μM=1.35*SI_{NIR780}-0.075*SI_{NIR700}

The calculated compensation is 5.5% and 22% of the total signal intensity in the low NIR and high NIR channels, respectively, at equal concentrations of the two fluorochromes.

### Example

The following example demonstrates the feasibility of imaging perfusion and enzyme activity with the optical imaging system described herein in a spontaneous colon tumor model. Colonoscopy was performed using the new optical imaging system in APCMin+/− mice (age 20-30 weeks) obtained from the Jackson Laboratories (Bar Harbor, Me.). These mice have a heterozygous deletion in the APC-gene, which results in intestinal polyposis that mimics human disease. The endoscope of the optical imaging system was lubricated with water and was introduced rectally into the anesthetized mouse. The colon was gently insufflated with air, while keeping the mean pressure less than 10 mmHg to avoid overinsufflation of the entire bowel, which could lead to perforation of the bowel or regurgitation of fluid through the esophagus. As the endoscope was gently advanced into the colon, the abdomen was observed both to localize the tip of the endoscope with transillumination and to monitor for overinflation. The average length of insertion was 4 cm, and each examination required 10 to 15 minutes to perform.

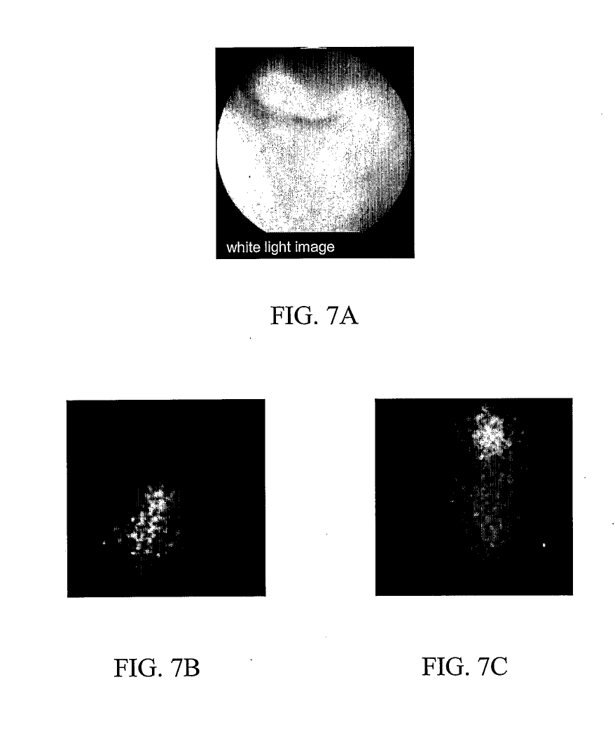

Using the white-light channel of the optical imaging system, four animals carrying spontaneous polyps in the descending colon or sigmoid were identified. The preinjection (unenhanced) fluorescence intensities of each lesion were recorded. These four animals underwent intravenous injection of 2 nmol/mouse of a Cy7 protease imaging probe fluorescent in the band of the high NIR channel. Colonoscopy with the optical imaging system was repeated 24 hours later, the time at which the peak fluorescence intensity of the protease probe occurs. During this second investigation, a perfusion imaging agent that fluoresces in the band of the low NIR channel, indocyanine dye Cy5.5 conjugated to a crosslinked iron oxide nanoparticle, was injected at a dose of 1 nmol/mouse. The fluorescence intensity of the adenomas and of normal bowel wall were recorded in both NIR channels before and after injection of the second contrast agent, to demonstrate the ability to separate these two different markers. Simultaneously captured images, taken after injection of the protease imaging probe and perfusion imaging agent, for the white light channel, low NIR channel, and high NIR channel are shown in FIGS. 7A, 7B, and 7C, respectively.

The white light image in FIG. 7A shows smooth surface features for a portion of a biological tissue. The low NIR channel image in FIG. 7B shows bright spots in a lower left portion of the image corresponding to the perfusion imaging agent with some crosstalk due to the protease imaging probe. The high NIR channel image in FIG. 7C shows bright spots in an upper portion of the image corresponding to the protease imaging probe with some crosstalk due to the perfusion imaging agent.

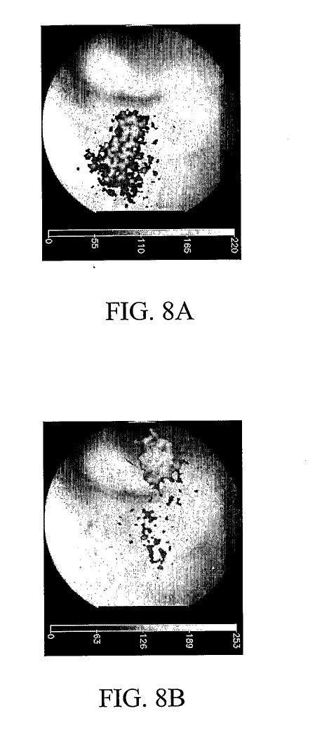

Cross talk compensation (i.e., the coefficients calculated above) was performed on the NIR channels, as described above, and the resulting images were fused with the white light channel image as shown in FIGS. 8A and 8B. The fused image in FIG. 8A shows the surface features of the white light image along with the spots in the lower left of the reduced-crosstalk low NIR channel image corresponding to the perfusion imaging agent. The fused image in FIG. 8B shows the surface features of the white light image along with the spots in the upper portion of the reduced-crosstalk high NIR channel image corresponding to the protease imaging probe.

As noted above, the correction introduced into the low NIR channel was 5.5% whereas a larger correction of 22% was introduced into the high NIR channel. This asymmetry is due to the overlap and asymmetry of the tails of the Cy5.5 and Cy7 emission spectra. While there is almost no emission light from the fluorochrome emitting primarily in the high NIR channel recorded in the low NIR channel, the fluorochrome emitting primarily in the low NIR channel is still recorded to a moderate extent in the high NIR channel. The corrections were validated and shown to hold true in phantoms doped with known concentrations of fluorochrome mixtures (data not shown).

After colonoscopy with the optical imaging system, the animals were sacrificed and the colon was inspected in situ on a macroscopic scale using a custom-built epifluorescence imaging system prototype (Siemens, Erlangen, Germany). The localization and spectral distribution of the respective fluorescence signals that were detected at colonoscopy were recorded. In addition, the polyps were excised together with the adjacent normal colon, and tissue sections were processed for histology by staining with hematoxylin and eosin. Fluorescence recorded with the optical imaging system correlated both in spectral quality as well as in localization in all cases with the fluorescence observed ex vivo in the epifluorescence imaging system.

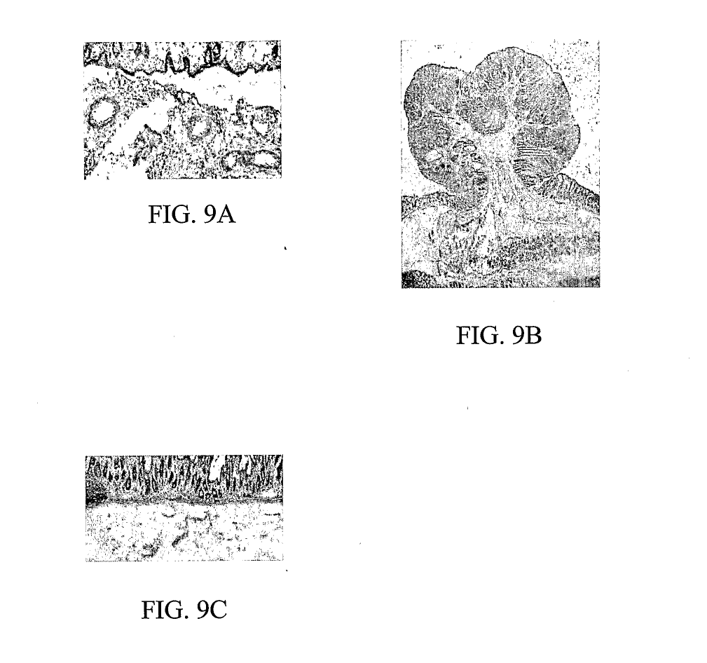

Colonoscopy was feasible in all animals. The colon could fully be inspected up to the splenic flexure. The polyps were easily identifiable after administration of the protease-activatible probe in the high NIR channel. The simultaneous application of the intravascular contrast agent, in contrast, showed a different spatial pattern. While the polyps showed only moderate and incomplete enhancement, the brightest regions in the low NIR channel were the hyperemic parts of the intestine, identifiable in the white light channel as red-hued parts of the mucosa. Subsequent histologic examination of magnified images of the targeted tissues (FIGS. 9A and 9B) compared with a magnified image of normal colon tissue (FIG. 9C) confirmed the correlation of high vascular density with high SI in the low NIR channel (FIG. 9A), and intestinal adenomas with high SI in the high NIR channel (FIG. 9B). The images in FIGS. 9A and 9C were acquired at 200× magnification, and the image in FIG. 9B was acquired at 20× magnification. Epithelial detachment in FIG. 9A reflects processing artifact.

Using a mouse model of colonic adenomatosis both perfusion and protease activity can be detected simultaneously, independently, and repeatedly in live mice. The simultaneous acquisition of two distinct parameters, namely vascularization and local enzyme activity, is feasible. The optical imaging system described herein can be used in repeated, non-destructive optical imaging of a multitude of molecular targets in any animal or in humans.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A beam splitter array including:
a first beam splitter that outputs a first beam of optical radiation having a power spectral density that includes wavelengths over at least 50% of a white light spectrum that includes wavelengths between about 400 nanometers and about 670 nanometers from a first output port, and that outputs a second beam of optical radiation having a power spectral density comprising a substantial portion of a first non-white light spectrum and a substantial portion of a second non-white light spectrum from a second output port, from an input beam received at a first angle of incidence;
a second beam splitter, arranged to receive the second beam at a second angle of incidence, that reflects a substantial portion of the second beam having a power spectral density comprising the first non-white light spectrum, and that transmits a substantial portion of the second beam having a power spectral density comprising the second non-white light spectrum; and
a reflector arranged to reflect a substantial portion of the beam transmitted by the second beam splitter.

2. The beam splitter array of claim 1, wherein the first output port comprises a surface of the first beam splitter through which light is transmitted, and the second output port comprises a surface of the first beam splitter from which light is reflected.

3. The beam splitter array of claim 1, wherein the first output port comprises a surface of the first beam splitter from which light is reflected, and the second output port comprises a surface of the first beam splitter through which light is transmitted.

4. The beam splitter array of claim 1, wherein the second beam splitter is further arranged to reflect the first beam in a first direction, and the reflector is further arranged to reflect the second beam in a second direction that is within 20° of the first direction.

5. The beam splitter array of claim 1, wherein the first beam splitter has an optical transmittance spectrum that is larger than 0.5 over at least 50% of the white light spectrum that includes wavelengths between about 400 nanometers and about 670 nanometers, and an optical reflectance spectrum that is larger than 0.5 over the first non-white light spectrum that does not overlap the white light spectrum and is larger than 0.5 over the second non-white light spectrum that does not overlap the white light spectrum or the first non-white light spectrum.

6. The beam splitter array of claim 5, wherein the second beam splitter has an optical reflectance spectrum that is larger than 0.5 over the first non-white light spectrum, and an optical transmittance spectrum that is larger than 0.5 over the second non-white light spectrum.

7. The beam splitter array of claim 5, wherein the reflector has an optical reflectance spectrum that is larger than 0.5 over the second non-white light spectrum.

8. The beam splitter array of claim 1, wherein the first non-white light spectrum comprises a near-infrared spectrum.

9. The beam splitter array of claim 1, wherein the first non-white light spectrum comprises a narrowband visible spectrum.

10. The beam splitter array of claim 1, wherein the first non-white light spectrum includes wavelengths between about 680 nanometers and about 720 nanometers.

11. The beam splitter array of claim 1, wherein the second non-white light spectrum includes wavelengths between about 760 nanometers and about 800 nanometers.

12. The beam splitter array of claim 1, further comprising:
a first filter that has a bandpass transmittance spectrum centered at about 700 nm arranged to receive the first beam; and
a second filter that has a bandpass transmittance spectrum centered at about 780 nm arranged to receive the second beam.

13. A system comprising:
a beam splitter array comprising
a first beam splitter that outputs a first beam of optical radiation having a power spectral density comprising a substantial portion of a white light spectrum from a first output port, and that outputs a second beam of optical radiation having a power spectral density comprising a substantial portion of a first non-white light spectrum and a substantial portion of a second non-white light spectrum from a second output port, from an input beam received at a first angle of incidence;
a second beam splitter arranged to receive the second beam at a second angle of incidence, that reflects a substantial portion of the second beam having a power spectral density comprising the first non-white light spectrum, and that transmits a substantial portion of the second beam having a power spectral density comprising the second non-white light spectrum; and
a reflector arranged to reflect a substantial portion of the beam transmitted by the second beam splitter;
a first filter that has a bandpass transmittance spectrum centered at about a center of the first non-white light spectrum arranged to receive a beam of optical radiation reflected from the second beam splitter at the second angle of incidence;
a second filter that has a bandpass transmittance spectrum centered at about a center of the second-non white light spectrum arranged to receive a beam of optical radiation reflected from the reflector;
a first waveguide arranged to deliver optical radiation radiated from a sample to the first beam splitter at the first angle of incidence;
a first detector arranged to receive a beam of optical radiation output from the first beam splitter at the first angle of incidence; and
a second detector arranged to receive a beam of optical radiation reflected from the second beam splitter and a beam of optical radiation reflected from the reflector.

14. The system of claim 13, wherein the first detector comprises a camera.

15. The system of claim 13, wherein the second detector comprises a single camera arranged to receive the beam of optical radiation reflected from the second beam splitter and the beam of optical radiation reflected from the reflector.

16. The system of claim 13, wherein the second detector comprises two cameras arranged to receive the beam of optical radiation reflected from the second beam splitter and the beam of optical radiation reflected from the reflector, respectively.

17. The system of claim 13, further comprising:
a source of optical radiation that includes white light; and
a second waveguide arranged to deliver the optical radiation produced by the source to the biological tissue.

18. The system of claim 13, wherein the source is filtered to reduce white light in the first non-white light spectrum and the second non-white light spectrum.

19. The system of claim 13, wherein the source comprises a broadband white light source combined with a narrowband non-white light source.

20. The system of claim 19, wherein the broadband white light source comprises a xenon lamp.

21. The system of claim 19, wherein the narrowband non-white light source comprises a laser diode.

22. A method comprising:
illuminating a sample with optical radiation from a source of optical radiation that includes white light;
collecting optical radiation from the sample;
delivering the collected optical radiation to a beam splitter array;
detecting a first image of optical radiation with a power spectral density that includes a white light spectrum from the beam splitter array;
detecting a second image of optical radiation with a power spectral density that includes a first non-white light spectrum from the beam splitter array; and
detecting a third image of optical radiation with a power spectral density that includes a second non-white light spectrum from the beam splitter array, wherein the second and third images are formed next to each other on a surface of a detector.

23. The method of claim 22, wherein the beam splitter array comprises:
a first beam splitter that outputs a first beam of optical radiation having a power spectral density comprising a substantial portion of a white light spectrum from a first output port, and that outputs a second beam of optical radiation having a power spectral density comprising a substantial portion of a first non-white light spectrum and a substantial portion of a second non-white light spectrum from a second output port, from an input beam received at a first angle of incidence;
a second beam splitter, arranged to receive the second beam at a second angle of incidence, that reflects a substantial portion of the second beam having a power spectral density comprising the first non-white light spectrum, and that transmits a substantial portion of the second beam having a power spectral density comprising the second non-white light spectrum; and
a reflector arranged to reflect a substantial portion of the beam transmitted by the second beam splitter.

24. The method of claim 23, wherein the first output port comprises a surface of the first beam splitter through which light is transmitted, and the second output port comprises a surface of the first beam splitter from which light is reflected.

25. The method of claim 23 wherein the first output port comprises a surface of the first beam splitter from which light is reflected, and the second output port comprises a surface of the first beam splitter through which light is transmitted.

26. The method of claim 22, wherein the first, second, and third images are detected simultaneously.

27. The method of claim 22, wherein the first, second, and third images are recorded.

28. The method of claim 22, further comprising combining two or more of the first, second, and third images using a mathematical function.

29. The system of claim 15, wherein the beam of optical radiation reflected from the second beam splitter and the beam of optical radiation reflected from the reflector are far enough apart on the camera for the images not to overlap.

30. The method of claim 22, wherein the second image and the third image are far enough apart on the surface for the images not to overlap.
